(19) United States
(12) Patent Application Publication
(10) Pub. No.: US 2002/0015807 A1
(43) Pub. Date: Feb. 7, 2002

(54) Polarizer, polarizing plate, and liquid crystal display using the same

(76) Inventors: Youichirou Sugino, Osaka (JP); Yuuji Saiki, Osaka (JP); Senri Kondou, Osaka (JP); Eiji Hamamoto, Osaka (JP); Seiichi Kusumoto, Osaka (JP); Hisashi Mihara, Osaka (JP); Kazuki Tsuchimoto, Osaka (JP)

Correspondence Address: ROSENTHAL & OSHA LLP, SUITE 4550, 700 LOUISIANA, HOUSTON, TX, 77002

(21) Appl. No.: 09/882,671

(22) Filed: Jun. 15, 2001

(30) Foreign Application Priority Data
Jun. 19, 2000 (JP) 2000-182842
Dec. 7, 2000 (JP) 2000-373338

(51) Int. Cl. C09K 19/00

(52) U.S. Cl. 428/1.31; 428/522; 428/507

(57) ABSTRACT

The present invention provides a polarizer and a polarizing plate having less dimensional changes to heat stress. The present invention provides also a liquid crystal display that includes the polarizer and the polarizing plate, and is free of color irregularity or decoloration. The polarizer has shrinkage force of not more than 4.0 N/cm in the absorption axis direction after being heated at 80° C. for 30 minutes. A protective film is laminated on at least one surface of the polarizer in order to form a polarizing plate, and the polarizing plate has a following relationship of 0.01≦A/B≦0.16 when A denotes a thickness of the polarizer and B denotes a thickness of the protective film.

### BACKGROUND OF THE INVENTION

1. Field of the Invention

This invention relates to a polarizing plate used for a liquid crystal display (LCD) and a liquid crystal display comprising such a polarizing plate.

2. Description of the Related Art

Recently, demand for LCDs used for personal computers has increased significantly. Recently, such LCDs are used for monitoring as well.

A polarizing plate used for a LCD is manufactured, for example, by a method comprising steps of dyeing a polyvinyl alcohol (PVA) film with dichroic iodine or a dichroic dyestuff, crosslinking with an ingredient such as boric acid and borax, stretching uniaxially, and subsequently drying and sticking to a protective film (protective layer) such as triacetylcellulose (TAC). The respective steps of dyeing, crosslinking and stretching can be carried out simultaneously instead of being performed separately. There is no limitation on the order of the steps.

However, a polarizing plate formed by dyeing, crosslinking, stretching and drying a PVA film maintains stress generated at the time of stretching. Therefore, when the polarizing plate is applied with any external force, the polarizer cannot withstand the residual stress and cause shrinkage, distortion or the like. As a result, the polarizing plate also will have a dimensional change. Use of such a polarizing plate for a liquid crystal display can cause inconveniences such as color irregularity or decoloration in the display. Since a plastic substrate is thin and has a lower relative density when compared to a glass substrate, a liquid crystal display comprising such a plastic substrate can be lighter in weight and thinner than a liquid crystal display comprising a glass substrate. However, plastics will be subjected to dimensional changes easily due to the coefficient of thermal expansion larger than that of glass by at least one order.

### SUMMARY OF THE INVENTION

The present invention provides a polarizer, a polarizing plate that can control or dissolve inconveniences such as color irregularity or decoloration in the display, and a liquid crystal display using the same.

Since a conventional polarizer has a large shrinkage force in the absorption axis direction, it will have a dimensional change when the polarizer or a polarizing plate using the same is exposed to heat. This leads to color irregularity or decoloration in the panel when the polarizer or the polarizing plate is packaged in a liquid crystal display. Dimensional change or warping in a panel can be corrected by decreasing residual stress applied to the entire polarizing plate. For this purpose, residual stress in a polarizer, which is generated during manufacturing (stretching) of the polarizer, is suppressed with a protective layer in order to decrease the residual stress applied to the entire polarizing plate. Specifically, shrinkage in the entire polarizing plate can be controlled by sticking a thicker protective film on the polarizer. Alternatively, film thickness of the polarizer can be reduced to decrease residual stress generated in the polarizer due to stretching and drying. In other words, shrinkage in a polarizer caused by heat stress or the like is decreased by decreasing the film thickness of the polarizer, and thus, the protective film is applied with less stress, so that shrinkage of the entire polarizing plate can be controlled. The present invention is carried out on the basis of the above estimation.

A first polarizer according to the present invention is formed by dyeing, crosslinking, stretching and drying a hydrophilic polymer film. Shrinkage force in an absorption axis direction of the polarizer is not more than 4.0 N/cm after the polarizer is heated at 80° C. for 30 minutes. The shrinkage force of the polarizer in the absorption axis direction preferably ranges from 1.0 N/cm to 3.7 N/cm.

Preferably, the polarizer thickness is at most 25 μm, and more preferably, it ranges from 10 μm to 18 μm.

Preferably, the hydrophilic polymer film used in formation of the polarizer is a polyvinyl alcohol-based film having a thickness of not more than 60 μm. Preferable polyvinyl alcohol has an average polymerization degree ranging from 500 to 10000, and an average saponification degree of at least 75 mol %.

Secondly, a polarizing plate according to the present invention is manufactured by laminating a protective film on at least one surface of the polarizer, and the polarizing plate satisfies a formula of 0.01≦A/B≦0.16, more preferably, 0.05≦A/B≦0.16, where A denotes a thickness of the polarizer, and B denotes a thickness of the protective film.

It is preferable in the polarizing plate that the protective film is at least 80 μm in thickness, or more preferably, the thickness ranges from 80 μm to 200 μm. Also, it is preferable that the protective film is a triacetylcellulose film.

It is preferable in the polarizing plate, that the protective film and the polarizer are attached by an adhesive, and that the adhesive comprises polyvinyl alcohol. In addition to that, an adhesive layer can be formed on at least one surface of the polarizing plate.

After being heated at 70° C. for 120 hours, a polarizing plate according to the present invention has a dimensional change rate in the longitudinal direction (MD) of as small as ±0.7% or less, and this indicates that the present invention provides a useful and qualified polarizing plate.

Moreover, a polarizing plate according to the present invention can have a lamination of at least one optical layer selected from a reflector, a transreflector, a retardation plate, a λ plate, a viewing angle compensating film, and a brightness-enhanced film. Preferably, the polarizing plate and the optical layer are laminated through an adhesive layer.

Thirdly, a liquid crystal display according to the present invention is characterized in that the polarizing plate is arranged on at least one surface of a liquid crystal cell. The liquid crystal cell comprises at least one substrate selected from a glass substrate and a plastic substrate. Since a polarizing plate of the present invention has less dimensional change, arrangement of this polarizing plate in a liquid crystal display can decrease decoloration at an end part of a display panel. Moreover, since uniform stress is applied to the liquid crystal in the cell, hue change of the panel can be prevented.

### BRIEF DESCRIPTION OF THE DRAWING

FIG. 1 is a cross-sectional view of a liquid crystal display according to the present invention.

### DETAILED DESCRIPTION OF THE INVENTION

First, the present invention provides a polarizer formed by dyeing, crosslinking, stretching and drying a hydrophilic polymer film, and the polarizer has a shrinkage force of not more than 4.0 N/cm in the absorption axis direction after being heated at 80° C. for 30 minutes. When the shrinkage force of the polarizer in the absorption axis direction is determined not to exceed 4.0 N/cm, a dimensional change of the polarizer can be prevented during a heating step. It is preferable that the shrinkage force ranges from 1.0 N/cm to 3.7 N/cm.

There is no specific limitation on a method of forming a polarizer having shrinkage force of not more than 4.0 N/cm, but such a polarizer is obtainable, for example, by making adjustment in stretching and crosslinking a polyvinyl alcohol-based film. More specifically, internal stress of a polarizer can be decreased by, for example,

1) using a PVA film of not more than 60 μm in thickness for the starting material;

2) stretching a PVA film at a low speed of not more than 2 m/minute in water;

3) stretching a PVA film in water and subsequently crosslinking the film with a crosslinking agent;

4) stretching a PVA film in a transverse direction and subsequently in a longitudinal direction;

5) stretching a PVA film, and subsequently relaxing stress at least once before a further stretching;

6) stretching before heating; and

7) decreasing the thickness of the polarizer to be 18 μm or less by using, for example, any of the methods described in the above 1) to 5).

In this specification, shrinkage force is equivalent to a calculated value of force per unit that a polarizer shrinks in an absorption axis direction after 30 minutes from a start of heating at 80° C. the polarizer 20 mm in width and 50 mm in length. In the measurement, a polarizer 20 mm in width is fixed at the one side, and the other side is pinched with two chucks having a force gauge, keeping a space of 50 mm (in the absorption axis direction), and heating the polarizer at 80° C. continuously for 30 minutes before reading values shown by the force gauge.

In the present invention, a polarizer is made of a hydrophilic polymer film, and the hydrophilic polymer film is treated appropriately, such as dyeing with dichroic substances such as iodine and dichroic agents, crosslinking and stretching in any suitable orders and manners before drying. Stretching ratio is not limited specifically, but it ranges from 3 to 7 times in general. The film can be swelled before the dyeing step if required. Any polarizer can be used, as long as it allows linearly polarized light to be transmitted when natural light enters. A polarizer with excellent light transmittance and excellent polarization degree is preferred particularly.

Preferably, the polarizer is 25 μm or less in thickness, more preferably, 18 μm or less, further preferably, ranging from 10 μm to 18 μm. When the thickness is 25 μm or less, residual stress generated in a polarizer due to stretching and drying is decreased, and thus, shrinkage of the polarizer under stress can be controlled. This will reduce stress applied to the protective film, and thus shrinkage in the entire polarizer can be controlled. Since polarizing plate deformation caused by shrinkage is decreased, panel hues at a time of packaging a liquid crystal display can be prevented.

The above-mentioned hydrophilic polymer film is selected, for example, from a polyvinyl alcohol-based film such as a polyvinyl alcohol film and partially-formalized polyvinyl alcohol film. Polyvinyl alcohol-based film is preferred because of the good iodine dye-affinity. The polyvinyl alcohol-based polymer can be provided by saponification after polymerization of vinyl acetate. Alternatively, it can be provided by copolymerizing vinyl acetate with a small amount of monomers that can be co-polymerized, e.g., unsaturated carboxylic acid and unsaturated sulfonic acid. It is preferable that the polyvinyl alcohol-based polymer has an average polymerization degree ranging from 500 to 10000 from an aspect of water-solubility of the film, and more preferably, ranging from 1000 to 6000. Preferable average saponification degree is at least 75 mol %, and more preferably, at least 98 mol %.

The polyvinyl alcohol-based film can be formed from an undiluted solution prepared by dissolving polyvinyl alcohol-based polymer in water or in an organic solvent in an arbitrary method selected from, for example, flow expansion, casting, and extrusion. The film is not more than 75 μm, or preferably, not more than 60 μm in thickness, and further preferable thickness range is from 20 μm to 50 μm. When the film thickness exceeds 50 μm, color variation in the display panel will be increased at a time of packaging thus manufactured polarizer in a liquid crystal display. When the thickness is less than 20 μm, the film may be difficult to stretch.

Secondly, a polarizing plate according to the present invention is produced by laminating a protective film on at least one surface of the above-mentioned polarizer, and the polarizing plate satisfies a formula of 0.01≦A/B≦0.16 where A denotes a thickness of the polarizer, and B denotes a thickness of the protective film. Optical properties suitable for a LCD cannot be obtained when A/B is less than 0.01, while the polarizing plate will have a great change in dimension when A/B exceeds 0.16. It is more preferable when 0.05≦A/B≦0.16. A transparent protective film as a protective layer is laminated on at least one surface of the polarizer in an appropriate adhesion treatment.

Such a protective film is provided to at least one surface of the polarizer. An appropriate transparent film can be used as a material of the protective film. An especially preferred film comprises polymers having excellent transparency, mechanical strength, thermal stability, moisture blocking property or the like. The polymers include, for example, an acetate-based resin such as triacetylcellulose, a polyester-based resin, a polyethersulfone-based resin, a polycarbonate-based resin, a polyamide-based resin, a polyimide-based resin, a polyolefine-based resin, an acrylic resin, and a polynorbornene-based resin, though the polymer is not limited to these resins. When some factors such as polarizing properties and durability are taken into consideration, an especially preferred transparent protective film is a triacetylcellulose film having surfaces saponified with alkali or the like. A transparent protective film to be provided on both surfaces of a polarizing film can be a film having surface polymers distinguished from polymers on the backside.

Preferably, the protective film is at least 80 μm in thickness, more preferably in a range from 80 μm to 200 μm, and further preferably, from 80 μm to 160 μm. When the thickness is 80 μm or more, residual stress in a polarizer, which is generated at a time of manufacturing (stretching) the polarizer, can be controlled. Especially, when the polarizer is subjected to heat stress, the polarizing plate will be applied with less stress by the increase in the thickness of the protective layer even if the polarizer residual stress applied to the protective layer is as same as that in the conventional technique. As a result, the polarizing plate changes less in dimension, and panel warping at a time of packaging a liquid crystal panel comprising a plastic substrate can be corrected, and thus, a change in the panel hue or other problems can be dissolved.

A transparent protective film used for the protective layer can be treated to provide properties such as hard coating, antireflection, anti-sticking, dispersion and anti-glaring, as long as the purposes of the present invention are not sacrificed.

Hard coating treatment is applied, for example, to prevent scratches on the surfaces of the polarizing plate. A surface of the transparent protective film can be applied with a coating film of a cured resin with excellent hardness and smoothness, e.g., a silicone-based ultraviolet-cure type resin. Antireflection treatment is applied to prevent reflection of outdoor daylight on the surface of the polarizing plate. Such an antireflection film or the like can be formed in a known method. Anti-sticking treatment is applied to prevent adherence of adjacent layers. Anti-glaring treatment is applied to prevent visibility of light transmitted through the polarizing plate from being hindered by outdoor daylight reflected on the polarizing plate surface. Anti-glare treatment can be carried out by providing microscopic asperity on a surface of a transparent protective film in an appropriate manner, e.g., by roughening the surface by sand-blasting or embossing, or by blending transparent particles.

The above-mentioned transparent fine particles will be selected from silica, alumina, titania, zirconia, stannic oxide, indium oxide, cadmium oxide, antimony oxide or the like, and the particles have an average diameter ranging from 0.5 μm to 20 μm. Inorganic fine particles having electroconductivity can be used as well. Alternatively, the particles can be organic fine particles comprising, for example, crosslinked or uncrosslinked polymer particles. An amount of the transparent fine particles ranges from 2 weight parts to 70 weight parts, and generally, from 5 weight parts to 50 weight parts, for 100 weight parts of a transparent resin.

An anti-glare layer comprising transparent fine particles can be provided as the transparent protective layer or a coating layer applied onto a transparent protective layer surface. The anti-glare layer can function as a diffusion layer to diffuse light transmitted through the polarizing plate in order to enlarge visual angles (this function is denoted as visual angle compensation). The above-mentioned layers such as the antireflection layer, the anti-sticking layer, the diffusion layer and the anti-glare layer can be provided as an sheet of optical layers comprising these layers separately from the transparent protective layer.

There is no specific limitation on treatment to adhere the polarizer and the protective film. Adhesion can be applied, for example, by using adhesives such as an adhesive comprising vinyl alcohol-based polymer, or an adhesive comprising at least the vinyl alcohol-based polymer and a water-soluble agent to crosslink the vinyl alcohol-based polymer, such as boric acid, borax, glutaraldehyde, melamine and oxalic acid. Such an adhesive layer is formed by, for example, applying and drying an aqueous solution, and an additive or a catalyst such as an acid can be blended in preparation of the aqueous solution if required. An adhesive comprising polyvinyl alcohol is used most preferably because such an adhesive has the best adherence with PVA (polarizer). Thickness of the adhesive layer is preferred to be in a range from 0.02 μm to 0.15 μm to achieve the purposes of the present invention, though there is no specific limitation.

A polarizer of the present invention can be laminated with another optical layer in order to be used as an optical member such as a polarizing plate. Though there is no specific limitation on the optical layer, one or more suitable optical layer applicable for formation of a liquid crystal display can be used, and the optical layer can be selected from, for example, a reflector, a transreflector, a retardation plate such as a λ plate like a half wavelength plate and a quarter wavelength plate, a viewing angle compensating film, and a brightness-enhanced film. Particularly preferred examples include a reflective polarizing plate or a semitransparent reflective polarizing plate formed by laminating an additional reflector or a transreflector on the above-mentioned polarizing plate comprising a polarizer and a protective layer according to the present invention; an elliptical polarizing plate or a circular polarizing plate formed by laminating an additional retardation plate on the above-mentioned polarizing plate comprising a polarizer and a protective layer; a polarizing plate having a viewing angle compensating film laminated additionally on the above-mentioned polarizing plate comprising a polarizer and a protective layer; and a polarizing plate having a brightness-enhanced film laminated additionally on the above-mentioned polarizing plate comprising a polarizer and a protective layer.

A reflector is provided to a polarizing plate in order to form a reflective polarizing plate. In general, such a reflective polarizing plate is arranged on a backside of a liquid crystal cell in order to make a liquid crystal display (a reflective liquid crystal display) to display by reflecting incident light from a visible side (display side). The reflective polarizing plate has some merits, for example, assembling of light sources such as backlight can be omitted, and the liquid crystal display can be thinned further. The reflective polarizing plate can be formed in an appropriate manner such as attaching a reflecting layer of metal or the like on one surface of the polarizing plate. For example, a transparent protective film is prepared by matting one of the surfaces if required. On this surface, a foil comprising a reflective metal such as aluminum or a deposition film is applied to form a reflecting layer.

An additional example of a reflective polarizing plate comprises the above-mentioned transparent protective film having a surface of a microscopic asperity due to contained fine particles, and also a reflecting layer corresponding to the microscopic asperity. The reflecting layer having a microscopic asperity surface diffuses incident light irregularly so that directivity and glare can be prevented and irregularity in color tones can be controlled. This transparent protective film can be formed by attaching a metal directly on a surface of a transparent protective film in any appropriate methods including deposition such as vacuum deposition, and plating such as ion plating and sputtering. Alternatively, the reflecting plate can be used as a reflecting sheet formed by providing a reflecting layer onto a proper film similar to the transparent protective film.

A semitransparent polarizing plate is provided by replacing the reflecting layer in the above-mentioned reflective polarizing plate by a semitransparent reflecting layer, and it is exemplified by a half mirror that reflects and transmits light at the reflecting layer. In general, such a semitransparent polarizing plate is arranged on a backside of a liquid crystal cell. In a liquid crystal display comprising the semitransparent polarizing plate, incident light from the visible side (display side) is reflected to display an image when a liquid crystal display is used in a relatively bright atmosphere, while in a relatively dark atmosphere, an image is displayed by using a built-in light source such as a backlight in the backside of the semitransparent polarizing plate. In other words, the semitransparent polarizing plate can be used to form a liquid crystal display that can save energy for a light source such as a backlight under a bright atmosphere, while a built-in light source can be used under a relatively dark atmosphere.

An elliptical polarizing plate or a circular polarizing plate described below comprises the above-mentioned polarizer and protective layer, and also comprises a laminated retardation plate.

A retardation plate is used for modifying linearly polarized light to either elliptical polarized light or circular polarized light, modifying either elliptical polarized light or circular polarized light to linearly polarized light, or modifying a polarization direction of linearly polarized light. For example, a retardation plate called a quarter wavelength plate (λ/4 plate) is used for modifying linearly polarized light to either elliptical polarized light or circular polarized light, and for modifying either elliptical polarized light or circular polarized light to linearly polarized light. A half wavelength plate (λ/2 plate) is used in general for modifying a polarization direction of linearly polarized light.

The above-described elliptical polarizing plate is effective in compensating (preventing) colors (blue or yellow) generated due to birefringence in a liquid crystal layer of a super twist nematic (STN) liquid crystal display so as to provide a black-and-white display free of such colors. Controlling three-dimensional refractive index is preferred further since it can compensate prevent) colors that will be observed when looking a screen of the liquid crystal display from an oblique direction. A circular polarizing plate is effective in adjusting color tones of an image of a reflective liquid crystal display that has a color image display, and the polarizing plate serves to prevent reflection as well.

The retardation plate is selected from, for example, a birefringent film prepared by stretching a polymer film, an oriented film of a liquid crystal polymer, and an oriented layer of a liquid crystal polymer that is supported by a film. Examples of polymers include, polycarbonate, polyvinyl alcohol, polystyrene, polymethyl methacrylate, polyolefins including polypropylene, polyalylate, polyamide, and polynorbornene.

A polarizing plate described below comprises the above-mentioned polarizer and protective layer, and further an additional viewing angle compensating film laminated on the polarizing plate.

A viewing angle compensating film is used for widen an visual angle so that an image can be clear relatively when a screen of a liquid crystal display is seen not in a direction perpendicular to the screen but in a slightly oblique direction. Such a viewing angle compensating film can be a triacetylcellulose film coated with a discotic liquid crystal, or a retardation plate. While an ordinary retardation plate is a birefringent polymer film that is stretched uniaxially in the face direction, a retardation plate used for an viewing angle compensating film is a two-way stretched film such as a birefringent polymer film stretched biaxially in the face direction and an incline-oriented polymer film with controlled birefringence in the thickness direction that is stretched uniaxially in the face direction and stretched also in the thickness direction. The incline-oriented film is prepared by, for example, bonding a heat shrinkable film onto a polymer film and stretching and/or shrinking the polymer film under an influence of shrinkage force provided by heat, or by orienting obliquely a liquid crystal polymer. A polymer as a material of the retardation plate is similar to the polymer used for the above-mentioned retardation plate.

A polarizing plate described below is produced by laminating a brightness-enhanced film additionally on the above-mentioned polarizing plate comprising a polarizer and a protective layer.

Generally, this polarizing plate is arranged on a backside of a liquid crystal cell. When natural light enters, by reflection from a backlight or a backside of a liquid crystal display etc., the brightness-enhanced film reflects linearly polarized light of a predetermined polarizing axis or circularly polarized light in a predetermined direction while the same film transmits other light. It allows entrance of light from a light source such as a backlight so as to obtain transmitted light in a predetermined polarization state, while reflecting light other than light in the predetermined polarization state. Light that is reflected at this brightness-enhanced film is reversed through a reflecting layer or the like arranged additionally behind the brightness-enhanced film. The reversed light that re-enters the luminance-improving plate is transmitted partly or entirely as light in a predetermined polarization state, so that light transmitting the brightness-enhanced film is increased and polarized light that is hardly absorbed in the polarizer is supplied. As a result, quantity of light available for the liquid crystal display etc. can be increased to improve luminance. When light enters through a polarizer from the backside of a liquid crystal cell by using a backlight or the like without using any brightness-enhanced films, most light is absorbed in the polarizer but not transmitted the polarizer if the light has a polarization direction inconsistent with the polarization axis of the polarizer. Depending on characteristics of the polarizer, about 50% of light is absorbed in the polarizer, and this decreases quantity of light available in the liquid crystal display or the like and makes the image dark. The brightness-enhanced film repeatedly prevents light having a polarization direction to be absorbed in the polarizer from entering the polarizer, and reflects the light on the brightness-enhanced film, reverses the light through a reflecting layer or the like arranged behind, and makes the light re-enter the luminance-improving plate. Since the polarized light that is reflected and reversed between them is transmitted only if the light has a polarization direction to pass the polarizer, light from a backlight or the like can be used efficiently for displaying images of a liquid crystal display in order to provide a bright screen.

There is no specific limitation on the brightness-enhanced film but any film can be used as long as it reflects either clockwise or counterclockwise circular polarized light while transmitting other light For example, it can be a multilayer thin film of a dielectric or a multilayer lamination of thin films with varied refraction aeolotropy. Preferable examples include cholesteric liquid crystal layers, more specifically, an oriented film of a cholesteric liquid crystal polymer or an oriented liquid crystal layer fixed onto a supportive substrate. Therefore, for a brightness-enhanced film to transmit linearly polarized light having a predetermined polarization axis, the transmission light enters the polarizing plate by matching the polarization axis so that absorption loss due to the polarizing plate is controlled and the light can be transmitted efficiently. For a brightness-enhanced film to transmit circular polarized light, i.e., a cholesteric liquid crystal layer, preferably, the transmission circular polarized light is converted to linearly polarized light before entering the polarizing plate in an aspect of controlling of the absorption loss, though the circular polarized light can enter the polarizer directly. Circular polarized light can be converted to linearly polarized light by using a quarter wavelength plate for a retardation plate.

A retardation plate having a function as a quarter wavelength plate in a wide wave range including a visible light region can be obtained, for example, by overlapping a retardation layer functioning as a quarter wavelength plate for monochromatic light such as light having 550 nm wavelength and another retardation plate showing a separate optical retardation property (e.g., a retardation plate functioning as a half wavelength plate). Therefore, a retardation plate arranged between a polarizing plate and a brightness-enhanced film can comprise a single layer or at least two layers of retardation layers. A cholesteric liquid crystal layer also can be provided by combining layers different in the reflection wavelength and it can be configured by overlapping two or at least three layers. As a result, the obtained retardation plate can reflect circular polarized light in a wide wavelength range including a visible light region, and this can provide transmission circular polarized light in a wide wavelength range.

Alternatively, a polarizing plate according to the present invention can be made by laminating a polarizing plate and two or at least three optical layers. In other words, the polarizing plate can be a reflective elliptical polarizing plate or a semitransparent elliptical polarizing plate, which is prepared by combining either the above-mentioned reflective polarizing plate or a semitransparent polarizing plate with a retardation plate. An optical member comprising a lamination of two or at least three optical layers can be formed in a method of laminating layers separately in a certain order for manufacturing a liquid crystal display etc. or in a method for preliminary lamination. Since an optical member that has been laminated previously has excellent stability in quality and assembling operability, efficiency in manufacturing a liquid crystal display can be improved Any appropriate adhesion means such as an adhesive can be used for laminating the polarizing plate and optical layers.

An adhesive layer can be provided to a polarizing plate or to an optical member in the present invention for adhesion with other members such as a liquid crystal cell. There is no specific limitation on the adhesive used for forming an adhesive layer, but appropriate adhesives include an acrylic adhesive, a silicone-based adhesive, a polyester-based adhesive, a polyurethane-based adhesive, a polyether-based adhesive and a rubber-based adhesive. Acrylic adhesives having a low moisture absorption coefficient and an excellent heat resistance is preferred from an aspect of prevention of foaming or peeling caused by moisture absorption or prevention of decrease in the optical properties and warping of a liquid crystal cell caused by difference in thermal expansion coefficients. As a result, a high quality liquid crystal display having excellent durability can be produced. The adhesive layer can include fine particles to obtain optical diffusivity. Adhesive layers can be provided to appropriate surfaces if required. For example, a polarizing plate comprising a polarizer and a protective layer can be provided with an adhesive layer on at least one surface of the protective layer. Thickness of a typical adhesive layer ranges from 10 μm to 30 μm though there is no specific limitation

When an adhesive layer is exposed on a surface of the polarizing plate or the optical member, preferably, the adhesive layer is covered with a separator by the time the adhesive layer is used so that contamination will be prevented. The separator can be made of an appropriate thin sheet by coating a peeling agent if required, and the peeling agent may be selected, for example, from a silicone-based agent, a long-chain alkyl-based agent, a fluorine-based agent, an agent comprising molybdenum sulfide or the like.

The above-described members composing a polarizing plate and an optical member, such as a polarizer, a transparent protective film, an optical layer and an adhesive layer, can have ultraviolet absorption power as a result of treatment with an ultraviolet absorber such as an ester salicylate compound, a benzophenone compound, a benzotriazole compound, a cyanoacrylate compound, and a nickel complex salt compound.

Thirdly, a polarizing plate according to the present invention is arranged on at least one surface of a liquid crystal cell comprising either a glass substrate or a plastic substrate in order to form various devices such as a liquid crystal display. It should be noted particularly that the polarizing plate is used preferably for a liquid crystal display comprising a plastic substrate liquid crystal cell. The liquid crystal display is selected from devices of conventionally known structures, such as transmission type, reflection type, or a transmission-reflection type. A liquid crystal cell to compose the liquid crystal display can be selected from appropriate cells of such as active matrix driving type represented by a thin film transistor, a simple matrix driving type represented by a twist nematic type and a super twist nematic type.

When polarizing plates or optical members are arranged on both surfaces of a liquid crystal cell, the polarizing plates or the optical members on the surfaces can be the same or can be varied. Moreover, for forming a liquid crystal display, one or at least two layers of appropriate members such as a prism array sheet, a lens array sheet, an optical diffuser and a backlight can be arranged at proper positions.

The present invention will be described below more specifically by referring to Examples and Comparative Examples.

### EXAMPLE 1

A PVA powder having an average polymerization degree of 1700 and an average saponification degree of 97.0 mol % was dissolved in pure water and adjusted to prepare an aqueous solution of 10 wt %. The solution was applied on a polyester film and dried at 50° C. for two hours, and dried further at 130° C. for 30 minutes in order to provide a PVA film 40 μm in thickness. The film was swelled for one minute in 30° C. water, and then dipped in a 30° C. aqueous solution containing potassium iodide and iodine, and doubled in length along a predetermined axis by stretching. The ratio of the potassium iodide to the iodine in the aqueous solution was 10:1 by weight. Next, the film was further stretched in an aqueous solution comprising 4 wt % of boric acid at 50° C. to have a final stretching ratio triple that of the original, and further dipped in 30° C. water to wash, dried at 50° C. for four minutes, so that a polarizer 13 μm in thickness was obtained. The concentration of iodine in the above-identified aqueous solution was 0.35 wt % so that the polarizer had a transmittance of 44%.

### EXAMPLE 2

A PVA powder having an average polymerization degree of 1700 and an average saponification degree of 97.0 mol % was dissolved in pure water and adjusted to prepare an aqueous solution of 10 wt %. The solution was applied on a polyester film and dried at 50° C. for two hours, and dried further at 130° C. for 30 minutes in order to provide a PVA film 55 μm in thickness. The film was swelled for one minute in 30° C. water, and dipped in a 30° C. aqueous solution containing potassium iodide and iodine, and doubled in length along a predetermined axis by stretching. Ratio of the potassium iodide to the iodine in the aqueous solution was 10:1 by weight. Next, the film was stretched in an aqueous solution comprising 4 wt % of boric acid at 50° C. to have a final total stretching ratio triple that of the original, and further dipped in 30° C. water to wash, dried at 50° C. for four minutes, so that a polarizer 18 μm in thickness was obtained. The concentration of iodine in the above-identified aqueous solution was 0.33 wt % so that the polarizer had a transmittance of 44%.

### EXAMPLE 3

A PVA film 40 μm in thickness obtained in Example 1 was swelled for one minute in 30° C. water, and dipped in a 30° C. aqueous solution of potassium iodide and iodine to be tripled in length along a predetermined axis by stretching. Ratio of the potassium iodide to the iodine in the aqueous solution was 10:1 by weight. Next, the film was further stretched in an aqueous solution comprising 4 wt % of boric acid at 50° C. to have a final total stretching ratio 5.5 times that of the original, and further dipped in 30° C. water to wash, dried at 50° C. for four minutes, so that a polarizer 9 μm in thickness was obtained. The concentration of iodine in the above-identified aqueous solution was 0.37 wt % so that the polarizer had a transmittance of 44%.

### COMPARATIVE EXAMPLE 1

A PVA powder having an average polymerization degree of 1700 and an average saponification degree of 97.0 mol % was dissolved in pure water and adjusted to prepare an aqueous solution of 10 wt %. The solution was applied on a polyester film and dried at 50° C. for two hours, and dried further at 130° C. for 30 minutes in order to provide a PVA film 75 μm in thickness. The film was swelled for one minute in 30° C. water, and dipped in a 30° C. aqueous solution containing potassium iodide and iodine, and doubled in length along a predetermined axis by stretching. Ratio of the potassium iodide to the iodine in the aqueous solution was 10:1 by weight. Next, the film was further stretched in an aqueous solution comprising 4 wt % of boric acid at 50° C. to have a final total stretching ratio triple that of the original, and further dipped in 30° C. water to wash, dried at 50° C. for four minutes, so that a polarizer 31 μm in thickness was obtained. The concentration of iodine in the above-identified aqueous solution was 0.27 wt % so that the polarizer had a transmittance of 44%.

### COMPARATIVE EXAMPLE 2

A PVA powder having an average polymerization degree of 1700 and an average saponification degree of 97.0 mol % was dissolved in pure water and adjusted to prepare an aqueous solution of 10 wt %. The solution was applied on a polyester film and dried at 50° C. for two hours, and dried further at 130° C. for 30 minutes in order to provide a PVA film 75 μm in thickness. The film was swelled for one minute in 30° C. water, and dipped in a 30° C. aqueous solution containing potassium iodide and iodine, and tripled in length along a predetermined axis by stretching. Ratio of the potassium iodide to the iodine in the aqueous solution was 10:1 by weight. Next, the film was further stretched in an aqueous solution comprising 4 wt % of boric acid at 50° C. to have a final total stretching ratio 5.5 times that of the original, and further dipped in 30° C. water to wash, dried at 50° C. for four minutes, so that a polarizer 26 μm in thickness was obtained. The concentration of iodine in the above-identified aqueous solution was 0.30 wt % so that the polarizer had a transmittance of 44%.

### EXAMPLE 4

A PVA film 75 μm in thickness (trade name: VF-PS#750 supplied by KURARAY CO., LTD.) was used in this example. Similar to Example 1, the film was swelled in pure water and dyed in an aqueous solution containing a mixture of iodine and potassium iodide. Subsequently, the film was crosslinked with boric acid, stretched to five-times its original length along at least one predetermined axis and dried at 50° C. so as to manufacture a polarizer. This polarizer was 16 μm in thickness. Concentration of the iodine in the aqueous solution containing potassium iodide and iodine (weight ratio was 10:1) was set to be 0.35 wt % so that the polarizer had a transmittance of 44%.

### EXAMPLE 5

Similar to Example 4, a PVA film 75 μm in thickness was swelled in pure water and dyed in an aqueous solution containing a mixture of iodine and potassium iodide. Subsequently, the film was crosslinked with boric acid, stretched to six-times its original length along at least one predetermined axis and dried at 50° C. so as to manufacture a polarizer. This polarizer was 25 μm in thickness. Concentration of the iodine in the aqueous solution containing potassium iodide and iodine (weight ratio was 10:1) was set to be 0.35 wt % so that the polarizer had a transmittance of 44%.

### COMPARATIVE EXAMPLE 3

Similar to Example 1, a PVA film 75 μm in thickness was swelled in pure water and dyed in an aqueous solution containing a mixture of iodine and potassium iodide. Subsequently, the film was crosslinked with boric acid, stretched to five-times its original length along at least one predetermined axis and dried at 50° C. so as to manufacture a polarizer. This polarizer was 28 μm in thickness. Concentration of the iodine in the aqueous solution containing potassium iodide and iodine (weight ratio was 10:1) was set to be 0.35 wt % so that the polarizer had a transmittance of 44%.

### COMPARATIVE EXAMPLE 4

Similar to Example 1, a PVA film 75 μm in thickness was swelled in pure water and dyed in an aqueous solution containing a mixture of iodine and potassium iodide. Subsequently, the film was crosslinked with boric acid, stretched to five-times its original length along at least one predetermined axis and dried at 50° C. so as to manufacture a polarizer. This polarizer was 28 μm in thickness. Concentration of the iodine in the aqueous solution containing potassium iodide and iodine (weight ratio was 10:1) was set to be 0.35 wt % so that the polarizer had a transmittance of 44%.

### COMPARATIVE EXAMPLE 5

Similar to Example 1, a PVA film 75 film in thickness was swelled in pure water and dyed in an aqueous solution containing a mixture of iodine and potassium iodide. Subsequently, the film was crosslinked with boric acid, stretched to six-times its original length along at least one predetermined axis and dried at 50° C. so as to manufacture a polarizer. This polarizer was 25 μm in thickness. Concentration of the iodine in the aqueous solution containing potassium iodide and iodine (weight ratio was 10:1) was set to be 0.35 wt % so that the polarizer had a transmittance of 44%.

The polarizers obtained in the Examples and Comparative Examples were evaluated in the following manner.

(Shrinkage force of polarizer)

First, shrinkage force in an absorption axis (stretching axis) direction per unit width was measured for every polarizer manufactured in Examples or Comparative Examples at a time of heating the polarizer at 80° C. for 30 minutes. In the measurement, the polarizer was cut to be 70 mm in length and 20 mm in width so that the stretching direction will be the longitudinal direction. One side of the polarizer was fixed while the other side was pinched by two chucks having a force gauge to keep a spacing of 50 mm between the chucks. During the polarizer was heated at 80° C. for 30 minutes, shrinkage force per unit width was measured from values indicated by the force gauge.

(Dimensional change rate)

Next, a triacetylcellulose film having a thickness ranging from 60 μm to 210 μm and an elastic modulus of 3.43 GPa was stuck on both surfaces of the polarizer by using a PVA-based adhesive in order to manufacture a polarizing plate. Here, the adhesive layer was 0.08 μm in thickness. This polarizing plate was heated at 70° C. for 48 hours before measuring the dimensional change in order to calculate the dimensional change rate (%) in the stretching axis direction.

(Color irregularity and decoloration)

For evaluating color irregularity and decoloration, a polarizing plate made in the above-mentioned method was cut in a rectangular shape that is 300 mm in length and 200 mm in width so that the absorption axis direction would be 45°. This polarizing plate was stuck to both surfaces of a glass plate with the polarization axes crossing each other at right angles by using an acrylic adhesive having a thickness of 25 μm and comprising 95 weight parts butyl acrylate and 5 weight parts acrylic acid. The polarizing plate was heated at 70° C. for 48 hours before a visual observation of the color irregularity. In the evaluation, the polarizers were classified into three groups. Polarizing plates with less color irregularity were included in Group A. Polarizing plates with much color irregularity were included in Group C, while polarizers with medium color irregularity were included in Group B.

(Durability)

A polarizing plate manufactured in the above-mentioned method was cut to a size of 50 mm×50 mm to prepare two samples. These samples were heated at a temperature of 70° C. for 120 hours. Longitudinal dimension of each sample was measured before and after a heating test, and the dimensional change rate (%) of the samples were calculated from the following equation:

Dimensional change rate=[(La−Lb)/Lb]×100.

In the equation, Lb denotes a longitudinal (MD) dimension of the sample before a heating test, while La denotes a longitudinal (MD) dimension after the heating test.

The results are shown in Tables 1 and 2.

TABLE 1

| | | After Heating at 70° C. for 48 hours | |
|---|---|---|---|
| | | Dimensional | |
| | After heated at | change rate | |
| | 80° C. for 30 min. | in absorption | Color irregularity, |
| | Polarizer shrinkage | axis direction | decolor- |
| | force (N/cm) | (%) | ration |
| Example 1 | 1.6 | −0.18 | A |
| Example 2 | 2.4 | −0.21 | A |
| Example 3 | 3.3 | −0.30 | A |
| Example 4 | 3.5 | −0.37 | A |
| Example 5 | 3.5 | −0.37 | A |
| Com Ex. 1 | 5.6 | −0.39 | B |
| Com Ex. 2 | 11.4 | −0.45 | C |
| Com Ex. 3 | 12.3 | −0.86 | C |
| Com Ex. 4 | 15.0 | −0.97 | C |
| Com Ex. 5 | 12.3 | −0.69 | C |

TABLE 2

| | | Protective | | | |
|---|---|---|---|---|---|
| | Polarizer | film | | Dimensional change rate | |
| | thickness | thickness | Thickness | after heated at 70° C. | |
| | A | B | ratio | for 120 hours (%) | |
| | (μm) | (μm) | A/B | n = 1 | n = 2 |
| Example 1 | 13 | 120 | 0.108 | −0.308 | −0.251 |
| Example 2 | 18 | 120 | 0.150 | −0.302 | −0.230 |
| Example 3 | 9 | 80 | 0.113 | −0.429 | −0.398 |
| Example 4 | 16 | 120 | 0.133 | −0.660 | −0.612 |
| Example 5 | 25 | 210 | 0.119 | −0.480 | −0.435 |
| Com Ex. 1 | 31 | 120 | 0.258 | −0.736 | −0.367 |
| Com Ex. 2 | 26 | 120 | 0.217 | −0.776 | −0.452 |
| Com Ex. 3 | 28 | 80 | 0.350 | −0.935 | −0.975 |
| Com Ex. 4 | 28 | 60 | 0.467 | −1.228 | −1.194 |
| Com Ex. 5 | 25 | 120 | 0.208 | −0.729 | −0.724 |

*Com. E.: Comparative Example

As shown in Table 1, polarizing plates of the present invention having polarizer shrinkage force of not more than 4.0 N/cm have a dimensional change rate of 0.3% or less, which is smaller than that in any of Comparative Examples. In addition to that, the polarizing plates of the present invention have less color irregularity or decoloration. Similar effects were obtained when the PVA film thickness before stretching was 60 μm or less, and the polarizer thickness was 18 μm or less. As shown in Table 2, since the polarizing plate thickness A and the protective layer thickness B is in a range of 0.01≦A/B≦0.16 for the polarizing plates of the present invention, the dimensional change rate of the heated polarizing plates in the longitudinal direction (stretching direction) was as small as 0.7% or less.

### EXAMPLE 6

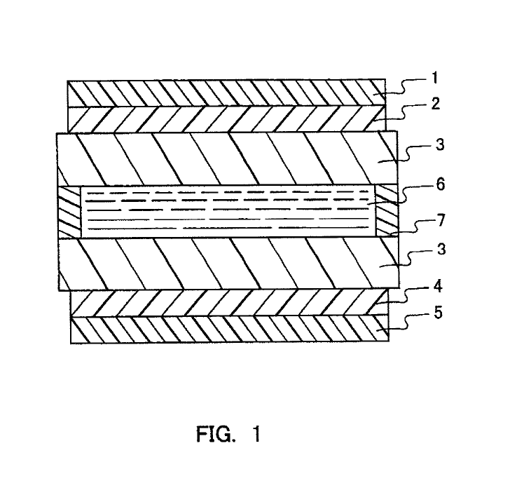

A polarizing plate manufactured in any of the Examples was adhered onto both surfaces of a liquid crystal cell having a plastic substrate 400 μm in thickness by using an acrylic adhesive in order to form a liquid crystal display. FIG. 1 is a cross-sectional view to exemplify the liquid crystal display. After a long time (500 hours) use of this liquid crystal display, substantially no decoloration at the panel ends or no hue variations in the panel were observed.

As mentioned above, since a polarizer in the present invention has a shrinkage force of not more than 4.0 N/cm per unit width after a heating at 80° C. for 30 minutes, it can compose a polarizing plate having less dimensional change, so that a liquid crystal display free of color irregularity or decoloration can be provided. Since thickness ratio of the polarizer to a protective layer of the polarizing plate are in a range of 0.01≦A/B≦0.16 where A denotes the polarizer thickness and B denotes the protective film thickness, the polarizing plate has less dimensional change. This serves to decrease panel warping at a time of packaging in a liquid crystal panel comprising a plastic substrate, and to reduce decoloration in the panel end parts. Moreover, since shrinkage force applied to the entire panel is decreased and the liquid crystal in the cells is applied with force uniformly, the present invention can prevent changes of the panel hue such as hue variations caused by heating. Therefore, the polarizer, the polarizing plate and the liquid crystal display according to the present invention are of much industrial importance.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, all changes that come within the meaning and range of equivalency of the claims are intended to be embraced therein.

What is claimed is:

1. A polarizer formed by dyeing, crosslinking, stretching and drying a hydrophilic polymer film, wherein the polarizer has shrinkage force of at most 4.0 N/cm in an absorption axis direction after being heated at 80° C. for 30 minutes.

2. The polarizer according to claim 1, wherein the shrinkage force in the absorption axis direction after being heated at 80° C. for 30 minutes ranges from 1.0 N/cm to 3.7 N/cm.

3. The polarizer according to claim 1, wherein the polarizer thickness is at most 25 μm.

4. The polarizer according to claim 3, wherein the polarizer thickness ranges from 10 μm to 18 μm.

5. The polarizer according to claim 1, wherein the hydrophilic polymer film is a polyvinyl alcohol-based film.

6. The polarizer according to claim 5, wherein the polyvinyl alcohol-based film thickness is at most 60 μm.

7. The polarizer according to claim 1, wherein the polyvinyl alcohol has an average polymerization degree ranging from 500 to 10000, and an average saponification degree of at least 75 mol %.

8. A polarizing plate comprising:
a polarizer having a shrinkage force of at most 4.0 N/cm in an absorption axis direction after being heated at 80° C. for 30 minutes; and
a protective film laminated on at least one surface of the polarizer, wherein the polarizing plate satisfies a relationship of 0.01≦A/B≦0.16 where A denotes a thickness of the polarizer and B denotes a thickness of the protective film.

9. The polarizing plate according to claim 8, satisfying a relationship of 0.05≦A/B≦0.16 where A denotes a thickness of the polarizer and B denotes a thickness of the protective film.

10. The polarizing plate according to claim 8, wherein thickness of the protective film is at least 80 μm.

11. The polarizing plate according to claim 10, wherein thickness of the protective film ranges from 80 μm to 200 μm.

12. The polarizing plate according to claim 10, wherein the protective film is a triacetylcellulose film.

13. The polarizing plate according to claim 8, wherein the protective film and the polarizer are attached by an adhesive.

14. The polarizing plate according to claim 13, wherein the adhesive is a polyvinyl alcohol-based adhesive.

15. The polarizing plate according to claim 13, wherein an additional adhesive layer is formed on at least one surface of the polarizing plate.

16. The polarizing plate according to claim 8, wherein the polarizing plate has a dimensional change rate of not more than ±0.7% in a longitudinal direction (MD) after being heated at 70° C. for 120 hours.

17. The polarizing plate according to claim 8 further comprising, at least one optical layer selected from a reflector, a transreflector, a retardation plate, a λ plate, a viewing angle compensating film, and a brightness-enhanced film.

18. The polarizing plate according to claim 17, wherein the polarizing plate and the optical layer are laminated through an adhesive layer.

19. A liquid crystal display comprising:
a liquid crystal cell; and
a polarizing plate disposed on at least one surface of the liquid crystal cell, wherein the polarizing plate comprises:
a polarizer having a shrinkage force of at most 4.0 N/cm in an absorption axis direction after being heated at 80° C. for 30 minutes; and
a protective film laminated on at least one surface of the polarizer, wherein the polarizing plate satisfies a relationship of 0.01≦A/B≦0.16 where A denotes a thickness of the polarizer and B denotes a thickness of the protective film.

20. The liquid crystal display according to claim 19, wherein the liquid crystal cell comprises at least one substrate selected from a glass substrate and a plastic substrate.
